(19) United States
(12) Patent Application Publication
(10) Pub. No.: US 2015/0195454 A1
(43) Pub. Date: Jul. 9, 2015

(54) IMAGERY CAPTURE

(71) Applicant: Google Inc., Mountain View, CA (US)

(72) Inventors: Frank Petterson, Mountain View, CA (US); Kathryn Cushing, San Francisco, CA (US); Sanjay G. Mavinkurve, Toronto (CA); Marshall Bock, San Francisco, CA (US); Scott Shumaker, San Francisco, CA (US)

(73) Assignee: Google Inc., Mountain View, CA (US)

(21) Appl. No.: 14/148,229

(22) Filed: Jan. 6, 2014

(51) Int. Cl. H04N 5/232

(52) U.S. Cl. CPC H04N 5/23245

(57) ABSTRACT

A method and computing system for determining a time differential between an image capture initiation indicator and an image capture completion indicator on a client electronic device. In response to a short time differential, a photograph is captured using the client electronic device. In response to a long time differential, a video is captured using the client electronic device.

### BACKGROUND

This disclosure concerns imagery capture processes and, more particularly, to imagery capture processes that allow for the capturing of both photographs and videos.

The Internet currently allows for the free exchange of ideas and information in a manner that was unimaginable only a couple of decades ago. One such use for the Internet is as a communication medium, whether it is via one-on-one exchanges or multi-party exchanges within social networks.

As is known in the art, social networks may allow for users to exchange content including, but not limited to, photographs and videos. Unfortunately, the controls that are included within the client electronic devices that are used to capture these photographs and videos are often cumbersome to use and require the user to perform multiple steps when e.g., transitioning from capturing photos to capturing videos.

### SUMMARY OF DISCLOSURE

In one implementation, a computer-implemented method includes determining a time differential between an image capture initiation indicator and an image capture completion indicator on a client electronic device. The image capture initiation indicator includes a user of the client electronic device depressing a button on the client electronic device. The image capture completion indicator includes a user of the client electronic device releasing a button on the client electronic device. In response to a short time differential: a photograph is captured using the client electronic device and the photograph is distributed via a text-messaging platform to which the client electronic device is coupled. In response to a long time differential: a video is captured using the client electronic device, and the video is distributed via the text-messaging platform to which the client electronic device is coupled.

In another implementation, a computer-implemented method includes determining a time differential between an image capture initiation indicator and an image capture completion indicator on a client electronic device. In response to a short time differential, a photograph is captured using the client electronic device. In response to a long time differential, a video is captured using the client electronic device.

One or more of the following features may be included. The image capture initiation indicator and the image capture completion indicator may be received from the client electronic device. The image capture initiation indicator may include a user of the client electronic device depressing a button on the client electronic device. The image capture completion indicator may include a user of the client electronic device releasing a button on the client electronic device. The photograph may be previewed after it is captured using the client electronic device. The photograph may be edited on the client electronic device. The photograph may be distributed via a text-messaging platform to which the client electronic device is coupled. The video may be previewed after it is captured using the client electronic device. The video may be edited on the client electronic device. The video may be distributed via a text-messaging platform to which the client electronic device is coupled.

In another implementation, a computing system including a processor and memory is configured to perform operations including determining a time differential between an image capture initiation indicator and an image capture completion indicator on a client electronic device. In response to a short time differential, a photograph is captured using the client electronic device. In response to a long time differential, a video is captured using the client electronic device.

One or more of the following features may be included. The image capture initiation indicator and the image capture completion indicator may be received from the client electronic device. The image capture initiation indicator may include a user of the client electronic device depressing a button on the client electronic device. The image capture completion indicator may include a user of the client electronic device releasing a button on the client electronic device. The photograph may be previewed after it is captured using the client electronic device. The photograph may be edited on the client electronic device. The photograph may be distributed via a text-messaging platform to which the client electronic device is coupled. The video may be previewed after it is captured using the client electronic device. The video may be edited on the client electronic device. The video may be distributed via a text-messaging platform to which the client electronic device is coupled.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a imagery capture process according to an embodiment of the present disclosure;

FIG. 2 is a flowchart of the imagery capture process of FIG. 1 according to an embodiment of the present disclosure;

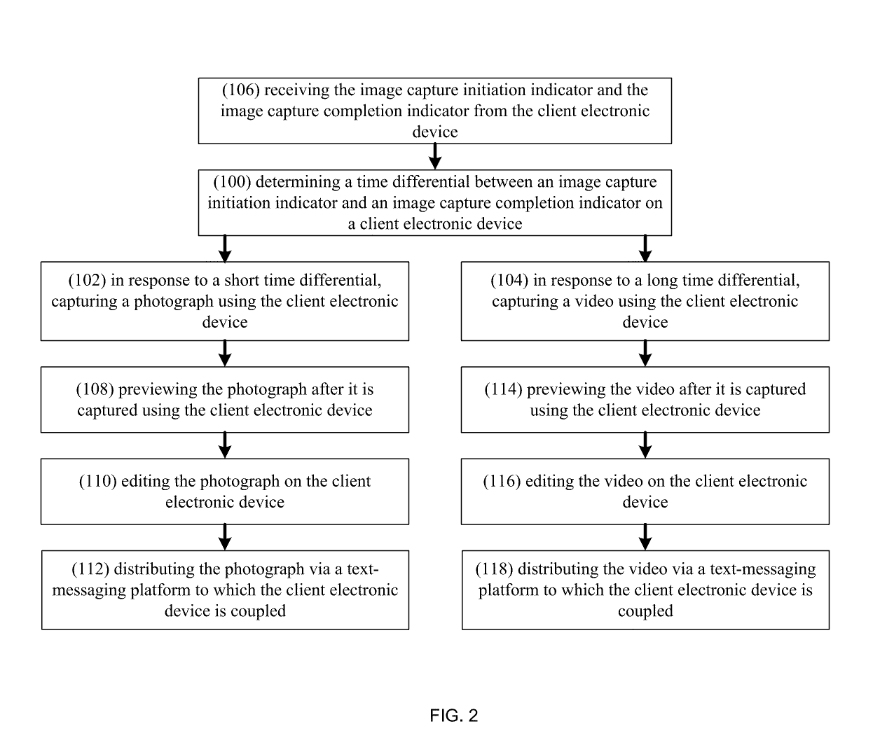

FIGS. 3A-3B are diagrammatic views of a display screen rendered by the imagery capture process of FIG. 1 according to an embodiment of the present disclosure;

FIGS. 4A-4B are diagrammatic views of a display screen rendered by the imagery capture process of FIG. 1 according to an embodiment of the present disclosure;

FIGS. 5A-C are diagrammatic views of a display screen rendered by the imagery capture process of FIG. 1 according to an embodiment of the present disclosure; and

FIG. 6 is a diagrammatic view of the computing device of FIG. 1 according to an embodiment of the present disclosure.

Like reference symbols in the various drawings indicate like elements.

### DETAILED DESCRIPTION

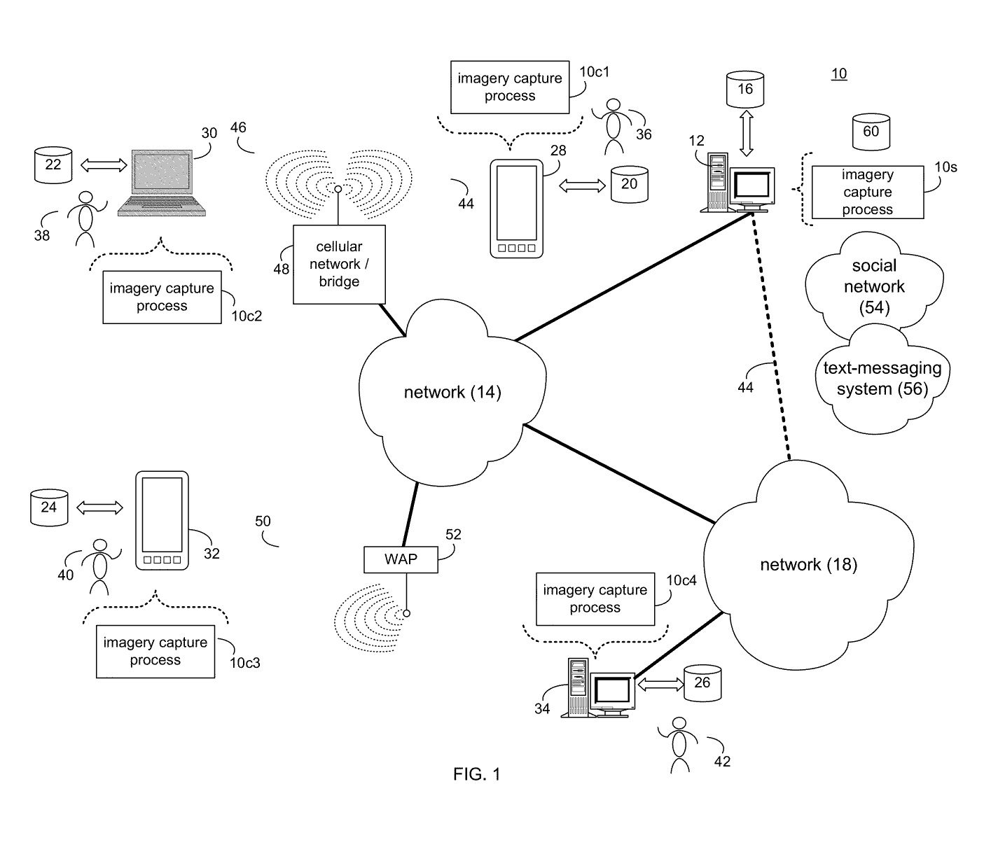

In FIGS. 1 & 2, there is shown imagery capture process 10. Imagery capture process 10 may be implemented as a server-side process, a client-side process, or a hybrid server-side/client-side process. For example, imagery capture process 10 may be implemented as a purely server-side process via imagery capture process 10s. Alternatively, imagery capture process 10 may be implemented as a purely client-side process via one or more of imagery capture process 10c1, imagery capture process 10c2, imagery capture process 10c3, and imagery capture process 10c4. Alternatively still, imagery capture process 10 may be implemented as a hybrid server-side/client-side process via imagery capture process 10s in combination with one or more of imagery capture process 10c1, imagery capture process 10c2, imagery capture process 10c3, and imagery capture process 10c4. Accordingly, imagery capture process 10 as used in this disclosure may include any combination of imagery capture process 10s, imagery capture process 10c1, imagery capture process 10c2, imagery capture process 10c3, and imagery capture process 10c4.

As will be discussed below in greater detail, imagery capture process 10 may determine 100 a time differential between an image capture initiation indicator and an image capture completion indicator on a client electronic device. In response to a short time differential, a photograph may be captured 102 using the client electronic device. In response to a long time differential, a video may be captured 104 using the client electronic device.

Imagery capture process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of imagery capture process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of imagery capture processes 10c1, 10c2, 10c3, 10c4 may include but are not limited to a web browser, a game console user interface, a social network user interface, a text-messaging user interface, or a specialized application. The instruction sets and subroutines of imagery capture processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, data-enabled, cellular telephone 32, personal computer 34, a tablet computer (not shown), a notebook computer (not shown), a server computer (not shown), a smart television (not shown), a gaming console (not shown), and a dedicated network device (not shown). Client electronic devices 28, 30, 32, 34 may each execute an operating system.

Users 36, 38, 40, 42 may access imagery capture process 10 directly through network 14 or through secondary network 18. Further, imagery capture process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, data-enabled, cellular telephone 32 is shown wirelessly coupled to network 14 via wireless communication channel 50 established between data-enabled, cellular telephone 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between data-enabled, cellular telephone 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As is known in the art, users of social networks (e.g., social network 54) may be able to participate in group communication sessions (e.g., text messaging sessions, video conferencing sessions) that may allow people to communicate about various topics.

Imagery capture process 10 may be included within, executed within, or a portion of social network 54. Alternatively, imagery capture process 10 may be included within, executed within, or a portion of text-messaging system 56. Further, imagery capture process 10 may be a stand-alone application that may be configured to interface with social network 54 and/or text-messaging system 56. Additionally, text-messaging system 56 may be included within, executed within, or a portion of social network 54.

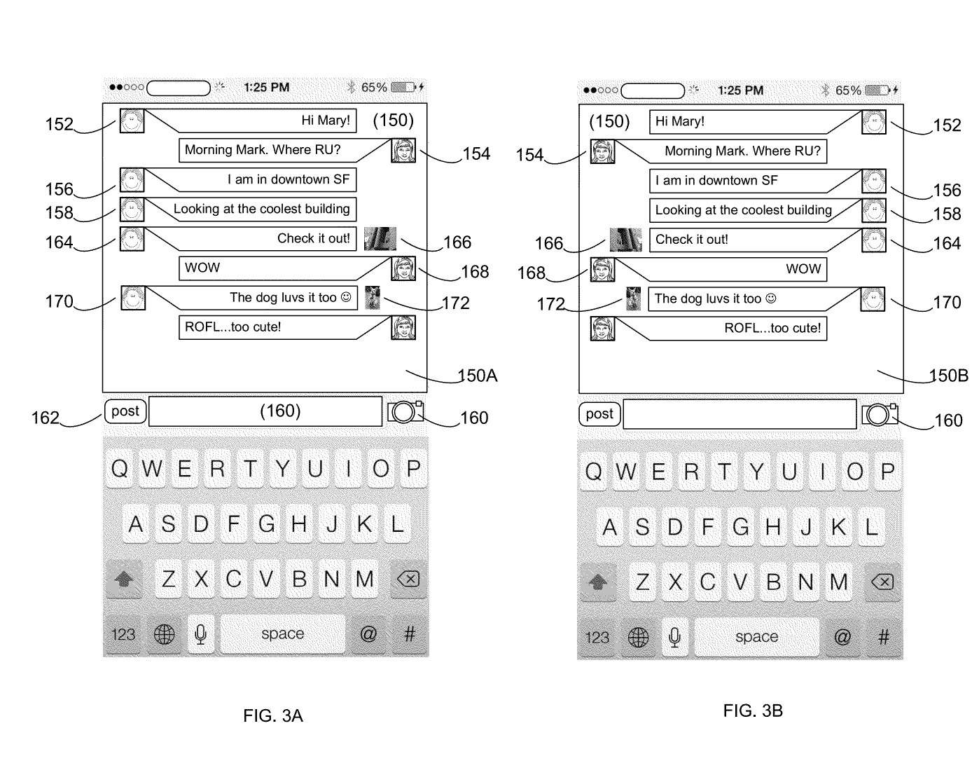

Referring also to FIGS. 3A-3B, assume for illustrative purposes that text- messaging system 56 is included within, executed within, or a portion of social network 54. Further assume that user 36 (i.e. Mark) is communicating with user 40 (i.e., Mary) using text messaging user interface 150 rendered by text-messaging system 56. For illustrative purposes, further assume that imagery capture process 10 is included within, executed within, or a portion of text-messaging system 56.

Assume that users 36, 38 each use text messaging user interface 150 to communicate with each other. Accordingly, a first instantiation (e.g., instantiation 150A) of text messaging user interface 150 may be rendered for user 36 (by text-messaging system 56) on data-enabled, cellular telephone 28 (as shown in FIG. 3A) and a second instantiation (e.g., instantiation 150B) of text messaging user interface 150 may be rendered for user 40 (by text-messaging system 56) on data-enabled, cellular telephone 32 (as shown in FIG. 3B).

Accordingly and through text-messaging system 56, users 36, 40 may communicate with each other and exchange messages (e.g., text messages 152, 154, 156, 158). Assume that user 36 sees a really interesting building that he tells user 40 about in text message 158. User 36 may utilize imagery capture process 10 to capture a photograph (e.g., a still image) of this building and provide the same to user 40 via text-messaging system 56.

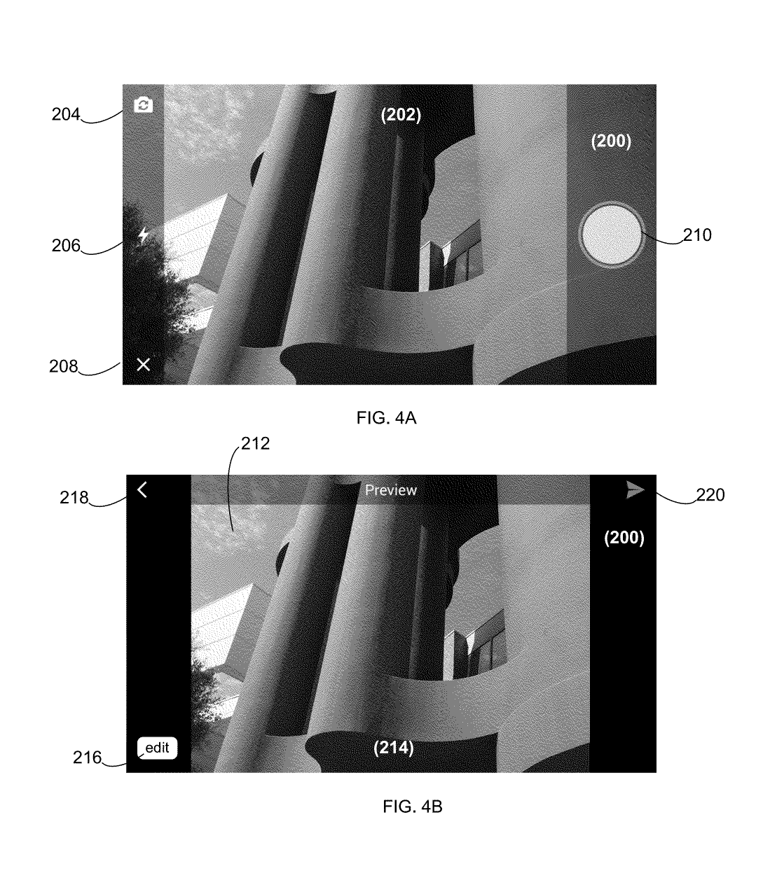

For example, user 36 may select “camera” icon 160, which may result in the launching of imagery capture process 10. Specifically and referring also to FIG. 4A, assume that user 36 wishes to take a picture of the above-referenced building. Upon selecting (e.g., by tapping) “camera” icon 160, imagery capture process 10 may render capture interface 200 that may be configured to allow user 36 to capture either photographs (e.g., still images) or videos (e.g., moving images). Further, capture interface 200 and imagery capture process 10 may be configured so that the user (e.g., user 36) may select between capturing photographs and capturing videos based upon the manner in which they use capture interface 200 (as opposed to requiring that e.g., user 36 proactively select between capturing a photograph and capturing a video).

Capture interface 200 may include a plurality of button that (in this case) user 36 may use to capture (in this case) the appropriate photo. For example, capture interface 200 may include viewfinder 202 within which user 36 may position the image to be captured (in this example, a photograph of the above-described building). Capture interface 200 may also include camera selector 204 (e.g., which may select between forward facing and rearward facing cameras), and flash selector 206 (e.g., which turn on the flash, turns off the flash, or places the flash into automatic mode). Capture interface 200 may also include cancel button 208 that may return user 36 to text messaging user interface 150.

Capture interface 200 may also include capture button 210 that may be configured to allow the user (e.g., user 36) to capture both photographs and videos. As discussed above, imagery capture process 10 may determine 100 a time differential between an image capture initiation indicator (e.g., user 36 depressing capture button 210) and an image capture completion indicator (e.g., user 36 releasing capture button 210) on a client electronic device (e.g., data-enabled, cellular telephone 28). Accordingly, imagery capture process 10 may receive 106 the above-described image capture initiation indicator and the above-described image capture completion indicator from (in this example) data-enabled, cellular telephone 28.

In response to a short time differential (such as user 36 quickly tapping capture button 210), a photograph may be captured 102 using the client electronic device (e.g., data-enabled, cellular telephone 28). However, in response to a long time differential (such as user 36 depressing and holding capture button 210 for longer than e.g., one second), a video may be captured 104 using the client electronic device (e.g., data-enabled, cellular telephone 28).

For example, imagery capture process 10 may be configured to immediately start recording a video upon capture button 210 being depressed (by user 36). In the event that user 36 releases capture button 210 within e.g., one second or less, a photograph may be captured upon the release of capture button 210 (and the video recorded thus far may be discarded). Alternatively, if user 36 continues to depress capture button 210 for longer than e.g., one second, the video recording previously initiated may continue until user 36 releases capture button 210.

Assume for illustrative purposes that user 36 wishes to capture a photograph of the above-described building. Accordingly, user 36 may quickly tap capture button 210, resulting in imagery capture process 10 capturing 104 a photograph of the above-described building. Referring also to FIG. 4B, imagery capture process 10 may preview 108 photograph 212 for user 36 within preview window 214 (after being captured 104 using data-enabled, cellular telephone 28). While photograph 212 is being previewed 108 within preview window 214, imagery capture process 10 may be configured to allow for editing 110 of photograph 212 using data-enabled, cellular telephone 28. For example, imagery capture process 10 may be configured to allow user 36 to edit 110 photograph 212 by e.g., selecting edit button 216, which may allow user 36 to: add text (e.g., luv this building); add emoticons (e.g., a smiley face), add memes (e.g., a text bubble proclaiming “I am one cool building”); adjust contrast/brightness/sharpness; and adjust picture type (e.g., color, grayscale, sepia).

In the event that user 36 does not like photograph 212, user 36 may select “cancel” button 218 and be taken back to the version of capture interface 200 shown in FIG. 4A. And in the event that user 36 is satisfied with photograph 212, user 36 may select “use” button 220, resulting in imagery capture process 10 distributing 112 photograph 212 via text-messaging system 56 (to which data-enabled, cellular telephone 28 is coupled). Through the use of message field 160, user 36 may associate text with photograph 212 being distributed 112 by imagery capture process 10. For example, user 36 may add the message “check it out!) and select “post” button 162, resulting in the generation of message 164. Message 164 may include a preview (e.g., photo preview 166) of photograph 212, thus allowing (in this example) user 40 to preview photograph 212 prior to downloading the same. Specifically, photo preview 166 of photograph 212 may be a low resolution/reduced scale version of photograph 212, thus resulting in much lower bandwidth utilization when compared to transferring a high-resolution/full scale version of photograph 212 to (in this example) data-enabled, cellular telephone 32 that is utilized by user 40. Upon reviewing photo preview 166 (or obtaining photograph 212), assume that user 40 sends message 168 to user 36.

As discussed above, in response to a short time differential (such as user 36 quickly tapping capture button 210), a photograph may be captured 102 using the client electronic device (e.g., data-enabled, cellular telephone 28). However, in response to a long time differential (such as user 36 depressing and holding capture button 210 for longer than e.g., one second), a video may be captured 104 using the client electronic device (e.g., data-enabled, cellular telephone 28).

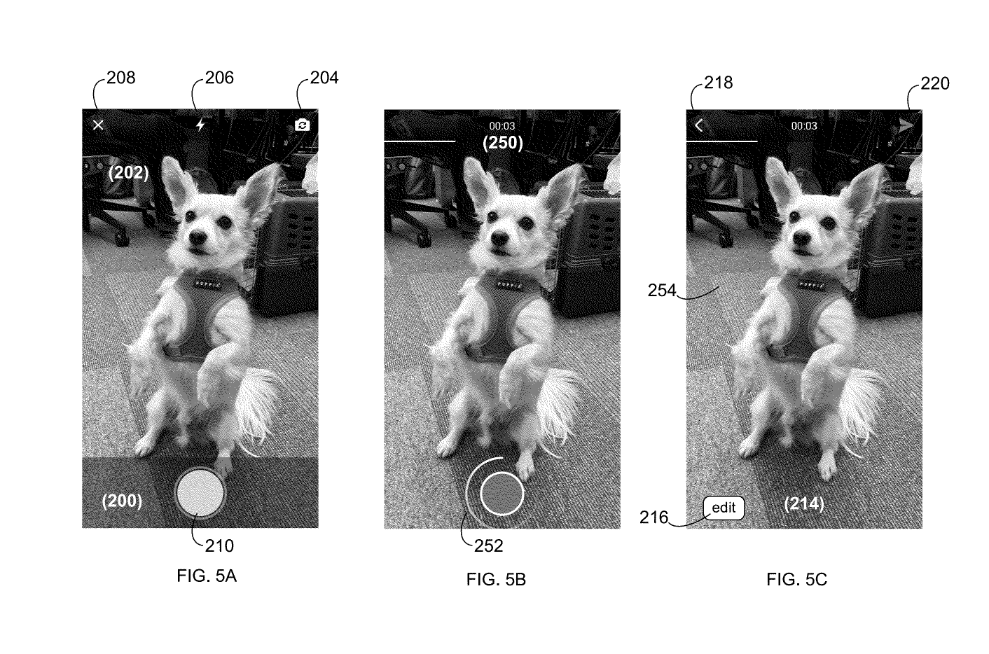

Assume that user 36 is with their dog and wishes to send a video (to user 40) of their dog standing on its hind legs. Accordingly, user 36 may select (e.g., by tapping) “camera” icon 160. Specifically and referring also to FIG. 5A, imagery capture process 10 may render capture interface 200. As discussed above, capture interface 200 may include a plurality of button that (in this case) user 36 may use to capture (in this case) the appropriate video. For example, capture interface 200 may include viewfinder 202 within which user 36 may position the image to be captured (in this example, a video of the above-described dog). Capture interface 200 may also include camera selector 204 (e.g., which may select between forward facing and rearward facing cameras), and flash selector 206 (e.g., which turns on the flash, turns off the flash, or places the flash into automatic mode). Capture interface 200 may also include cancel button 208 that may return user 36 to text messaging user interface 150.

Capture interface 200 may also include capture button 210 that may be configured to allow the user (e.g., user 36) to capture both photographs and videos. As discussed above, imagery capture process 10 may determine 100 a time differential between an image capture initiation indicator (e.g., user 36 depressing capture button 210) and an image capture completion indicator (e.g., user 36 releasing capture button 210) on a client electronic device (e.g., data-enabled, cellular telephone 28).

Accordingly, user 36 may depress and hold (e.g., for at least one second) capture button 210, resulting in imagery capture process 10 capturing 104 a video of their dog. Referring also to FIG. 5B, imagery capture process 10 may be configured to capture 104 the above-described video as long as user 36 is depressing (i.e., holding down) capture button 210. Imagery capture process 10 may define a maximum length for the above-described video (e.g., 10 seconds). If such a maximum length is defined, capture interface 200 may be configured to provide a remaining time indicator concerning the remaining time available for the above-described video. An example of such a remaining time indicator may include but is not limited to remaining time indicator 250 (which is shown to include a bar indicator and a time indicator). Additionally, capture interface 200 may be configured to provide visual indication that the above-described video is being recorded (such as sweeping arc animation 252).

Referring also to FIG. 5C, upon reaching the maximum recording length (e.g., 10 seconds) or user 36 releasing capture button 210, imagery capture process 10 may preview 114 video 254 for user 36 within preview window 214 (after being captured 106 using data-enabled, cellular telephone 28). When previewing 114 video 254 for user 36, imagery capture process 10 may render video 254 so that it is repeatedly played in a continuously-looping fashion.

While video 254 is being previewed 114 within preview window 214, imagery capture process 10 may be configured to allow for editing 116 of video 254 using data- enabled, cellular telephone 28. For example, imagery capture process 10 may be configured to allow user 36 to edit 116 video 254 by e.g., selecting edit button 216, which may allow user 36 to: add text (e.g., luv this dog); add emoticons (e.g., a smiley face), add memes (e.g., a text bubble proclaiming “I am a dancing machine”); adjust contrast/brightness/sharpness; and adjust picture type (e.g., color, grayscale, sepia).

In the event that user 36 does not like video 254, user 36 may select “cancel” button 218 and be taken back to the version of capture interface 200 shown in FIG. 5A. And in the event that user 36 is satisfied with video 254, user 36 may select “use” button 220, resulting in imagery capture process 10 distributing 118 video 254 via text-messaging system 56 (to which data-enabled, cellular telephone 28 is coupled). Through the use of message field 160, user 36 may associate text with video 254 being distributed 118 by imagery capture process 10. For example, user 36 may add the message “The dog luvs it too” and select “post” button 162, resulting in the generation of message 170. Message 170 may include a preview (e.g., video preview 172) of video 254, thus allow (in this example) user 40 to preview video 254 prior to downloading the same. Specifically, video preview 172 of video 254 may be a low resolution/reduced scale version of video 212 (such as an animated GIF file), thus resulting in much lower bandwidth utilization when compared to transferring a high-resolution/full scale version of video 254 to (in this example) data-enabled, cellular telephone 32 that is utilized by user 40. Imagery capture process 10 may render video preview 172 “in line” and positioned within the messages included within text messaging user interface 150, wherein video preview 172 may be repeatedly played in a continuously-looping fashion.

While imagery capture process 10 described above as being included within, executed within, or a portion of text-messaging system 56, this is for illustrative purposes only and is not intended to be a limitation of this disclosure, as other configurations are possible. For example, imagery capture process 10 may be a standalone application that may allow users of client electronic devices (that include cameras) to select between capturing photographs/videos by the manner in which they utilize capture interface 200 (as opposed to requiring that e.g., user 36 proactively select between capturing a photograph and capturing a video).

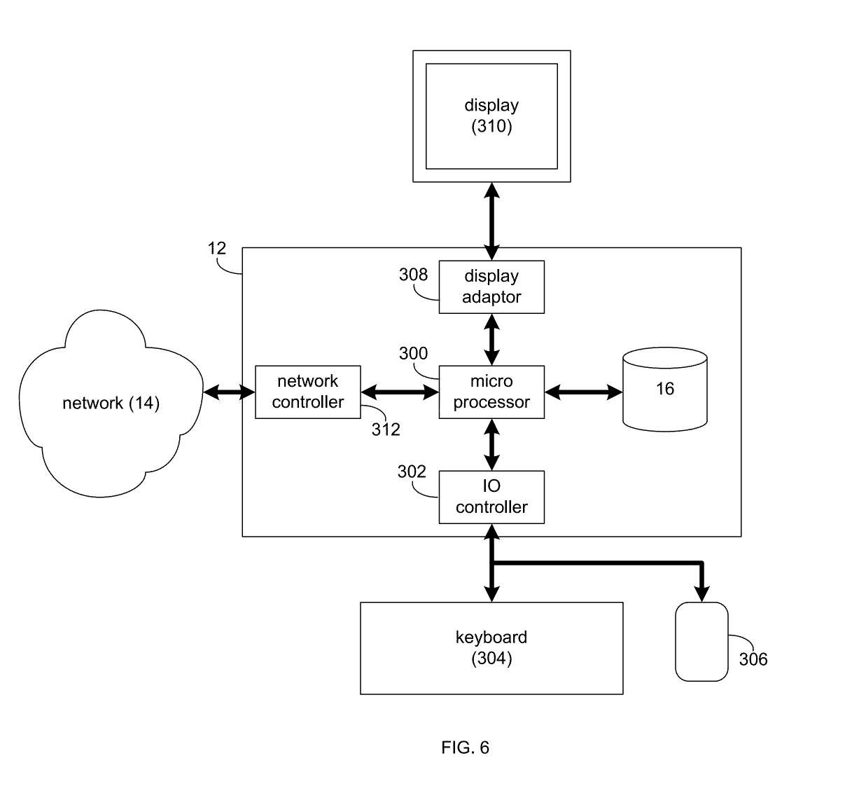

Referring also to FIG. 6, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, imagery capture process 10 may be substituted for computing device 12 within FIG. 4, examples of which may include but are not limited to client electronic devices 28, 30, 32, 34.

Computing system 12 may include microprocessor 300 configured to e.g., process data and execute instructions/code for imagery capture process 10. Microprocessor 300 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 302 may be configured to couple microprocessor 300 with various devices, such as keyboard 304, mouse 306, USB ports (not shown), and printer ports (not shown). Display adaptor 308 may be configured to couple display 310 (e.g., a CRT or LCD monitor) with microprocessor 300, while network adapter 312 (e.g., an Ethernet adapter) may be configured to couple microprocessor 300 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 300) of a general purpose computer/special purpose computer/other programmable data processing apparatus (e.g., computing device 12), such that the instructions, which execute via the processor (e.g., processor 300) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having described the disclosure of the present application in detail and by reference to embodiments thereof, it will be apparent that modifications and variations are possible without departing from the scope of the disclosure defined in the appended claims.

Wat is claimed is:

1. A computer-implemented method comprising:
determining a time differential between an image capture initiation indicator and an image capture completion indicator on a client electronic device, wherein: the image capture initiation indicator includes a user of the client electronic device depressing a button on the client electronic device, and the image capture completion indicator includes a user of the client electronic device releasing a button on the client electronic device;
in response to a short time differential:
capturing a photograph using the client electronic device, and
distributing the photograph via a text-messaging platform to which the client electronic device is coupled; and
in response to a long time differential:
capturing a video using the client electronic device, and distributing the video via the text-messaging platform to which the client electronic device is coupled.

2. A computer-implemented method comprising:
determining a time differential between an image capture initiation indicator and an image capture completion indicator on a client electronic device;
in response to a short time differential, capturing a photograph using the client electronic device; and
in response to a long time differential, capturing a video using the client electronic device.

3. The computer-implemented method of claim 2 further comprising:
receiving the image capture initiation indicator and the image capture completion indicator from the client electronic device.

4. The computer-implemented method of claim 2 wherein the image capture initiation indicator includes a user of the client electronic device depressing a button on the client electronic device.

5. The computer-implemented method of claim 2 wherein the image capture completion indicator includes a user of the client electronic device releasing a button on the client electronic device.

6. The computer-implemented method of claim 2 further comprising:
previewing the photograph after it is captured using the client electronic device.

7. The computer-implemented method of claim 6 further comprising:
editing the photograph on the client electronic device.

8. The computer-implemented method of claim 6 further comprising:
distributing the photograph via a text-messaging platform to which the client electronic device is coupled.

9. The computer-implemented method of claim 2 further comprising:
previewing the video after it is captured using the client electronic device.

10. The computer-implemented method of claim 9 further comprising:
editing the video on the client electronic device.

11. The computer-implemented method of claim 9 further comprising:
distributing the video via a text-messaging platform to which the client electronic device is coupled.

12. A computing system including a processor and memory configured to perform operations comprising:
determining a time differential between an image capture initiation indicator and an image capture completion indicator on a client electronic device;
in response to a short time differential, capturing a photograph using the client electronic device; and
in response to a long time differential, capturing a video using the client electronic device.

13. The computing system of claim 12 further configured to perform operations comprising:
receiving the image capture initiation indicator and the image capture completion indicator from the client electronic device.

14. The computing system of claim 12 wherein the image capture initiation indicator includes a user of the client electronic device depressing a button on the client electronic device.

15. The computing system of claim 12 wherein the image capture completion indicator includes a user of the client electronic device releasing a button on the client electronic device.

16. The computing system of claim 12 further configured to perform operations comprising:
previewing the photograph after it is captured using the client electronic device.

17. The computing system of claim 16 further configured to perform operations comprising:
editing the photograph on the client electronic device.

18. The computing system of claim 16 further configured to perform operations comprising:
distributing the photograph via a text-messaging platform to which the client electronic device is coupled.

19. The computing system of claim 12 further configured to perform operations comprising:
previewing the video after it is captured using the client electronic device.

20. The computing system of claim 19 further configured to perform operations comprising:
editing the video on the client electronic device.

21. The computing system of claim 19 further configured to perform operations comprising:
distributing the video via a text-messaging platform to which the client electronic device is coupled.
